(19) United States
(12) Patent Application Publication
(10) Pub. No.: US 2005/0240818 A1
(43) Pub. Date: Oct. 27, 2005

(54) System and method for processor diagnostic device with video controller

(76) Inventors: Don R. James JR., Houston, TX (US); Paul J. Broyles III, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/818,215

(22) Filed: Apr. 5, 2004

(51) Int. Cl. G06F 11/00

(52) U.S. Cl. 714/27

(57) ABSTRACT

One embodiment of a diagnostic system is a diagnostic device which tests at least one modular-processing device, comprising a coupler configured to communicatively mate with an access port residing on the modular-processing device, and a video controller configured to receive video information from the modular-processing device and configured to generate a video signal that is communicated to a display.

### BACKGROUND

Processing devices may be configured as modular units such that a plurality of modular-processing devices are coupled to a common chassis. The chassis is communicatively coupled to a network or other suitable communication system. Accordingly, the modular-processing devices may communicate with other devices and/or perform various network functions.

When a plurality of such modular-processing devices are coupled to the chassis, commonly-shared components may be shared by the modular-processing devices. Accordingly, the commonly-shared component may be omitted from individual modular-processing devices. Also, modular-processing devices are easily installed in or removed from the chassis. Thus, if one modular-processing device fails, a relatively low-skilled technician may remove the failed device and insert a replacement modular-processing device.

An example of a commonly-shared device is the power supply. The cost of one power supply that powers a plurality of modular-processing devices is typically less than the combined cost of individual power supplies installed in each one of the plurality of modular-processing devices. Maintenance of a single power supply may also be easier and less expensive in the long run.

Another example of a commonly-shared device is a fan or cooling system. The cost of a single fan or cooling system that is commonly used by the plurality of modular-processing devices is typically less than the combined cost of individual fans or cooling systems installed in each one of the plurality of modular-processing devices. Maintenance of a single fan or cooling system may also be easier and less expensive in the long run.

One example of a modular-processing device is a server blade. Many such server blades can be communicatively and physically coupled to a server chassis. The server blades commonly share the power supply, a fan or cooling system, and a communication interconnection interface that provides network access. Such server blades are stand-alone processing systems. Each server blade includes at least one processor and memory on a single circuit board or within a single enclosure. Server blades may be general purpose devices, or may be specific purpose devices (such as security blades, firewall blades or virtual private network blades). Server blades may also be installed with pre-loaded software.

Typically, modular-processing devices include convenient access ports to which diagnostic devices may be coupled. Accordingly, a technician may couple the diagnostic device to one of the modular-processing devices for testing. In the event that the diagnostic device includes, or is coupled to, a display device, the modular-processing device under test may provide a video signal to the diagnostic device. For example, if the diagnostic device includes or is coupled to a vector graphics array (VGA) compatible display or monitor, a VGA controller would reside in the modular-processing device to generate and communicate the video signal.

The cost of the VGA controller, or other video controller unit, may be a relatively significant cost of a modular-processing device. When the cost of installing a video controller unit in many modular-processing devices is considered, the overall cost will be significant.

### SUMMARY

One embodiment of a diagnostic system is a diagnostic device that tests at least one modular-processing device, comprising a coupler configured to communicatively mate with an access port residing on the modular-processing device, and a video controller configured to receive video information from the modular-processing device and configured to generate a video signal that is communicated to a display.

Another embodiment of a diagnostic system comprises a plurality of modular-processing devices, each of the modular-processing devices configured to communicate at least video information, a diagnostic device being configured to communicatively couple to one of the modular-processing devices, and a video controller residing in the diagnostic device and configured to receive the video information from the modular-processing device, and further configured to generate a video signal that is communicated to a display.

An embodiment of a method for diagnostic testing comprises receiving video information from one of the modular-processing devices, converting the received video information into a video signal using a video controller residing in the diagnostic device, and communicating the video signal to a display.

### BRIEF DESCRIPTION OF THE DRAWINGS

The components in the drawings are not necessarily to scale relative to each other. Like reference numerals designate corresponding parts throughout the several views.

FIG. 1 is an embodiment of a diagnostic device system and a plurality of modular-processing devices coupled to a system chassis.

FIG. 2 is a block diagram illustrating an embodiment of the diagnostic device.

FIG. 3 is a block diagram illustrating another embodiment of the diagnostic device of FIG. 1.

FIG. 4 shows a flow chart illustrating an embodiment of a process used by an embodiment of a diagnostic system.

### DETAILED DESCRIPTION

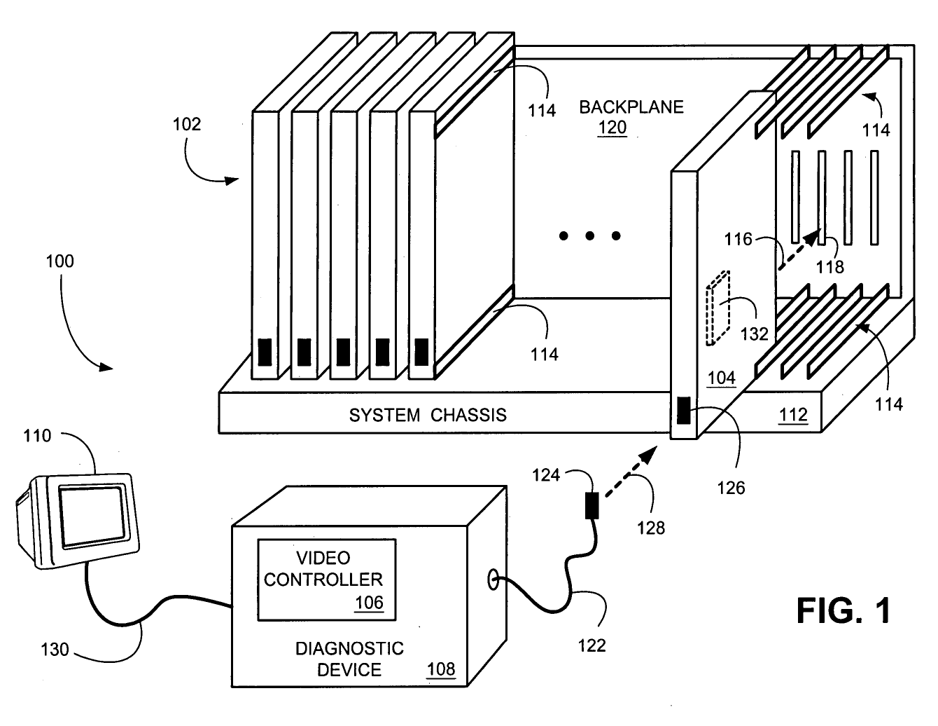

FIG. 1 is an embodiment of a diagnostic system 100 and a plurality of modular-processing devices 102 coupled to a system chassis 112. The diagnostic system 100 provides a system and method for receiving video information from a tested modular-processing device 104 such that a video controller 106 residing in the diagnostic device 108 generates a video signal in a suitable format that is communicated to display device 110. In one embodiment, the modular-processing devices 102 are server blades.

System chassis 112 comprises a plurality of guides 114 configured to receive the modular-processing devices 102. As illustrated, modular-processing device 104 is coupled to the system chassis 112 by aligning the modular-processing device 104 with two of the guides 114, and then by inserting the modular-processing device 104 into the system chassis 112, as indicated by the directional arrow 116.

The back side (not shown) of the modular-processing device 104 is configured to mate with a corresponding adapter 118 residing on the backplane 120 of the system chassis 112. The adapter 118 allows the modular-processing device 104 to be communicatively coupled to the backplane 120, thereby providing connectivity to a network or other suitable communication system (not shown) coupled to the system chassis 112.

Diagnostic device 108 includes a connection 122 with a coupler 124. Coupler 124 is a plug type attachment or other suitable connecting device. Coupler 124 is configured to communicatively mate with the access port 126 of the modular-processing device 104. Accordingly, a technician may couple the diagnostic device 108, via connection 122, to the modular-processing device 104 for testing of the modular-processing device 104, as indicated by the directional arrow 128.

When the diagnostic device 108 is coupled to display device 110, for instance via connection 130, the modular-processing device 104 under test provides video information to the diagnostic device 108. The video controller 106 processes the received video information and generates a suitable video signal. The video signal is communicated, for example via connection 130, to the display 110.

As disclosed herein, the modular-processing devices 102 do not include video cards. When a system comprises many modular-processing devices 102, cost savings may be significant since a single video controller 106 resides in the display device 108 (as compared to the cost of installing a video controller unit in many conventional modular-processing devices). A processor 132 residing in a modular-processing device 104 is configured to generate the video information in response to testing initiated by the diagnostic device. Accordingly, the video information communicated from the modular-processing device 104 is not suitable for communication to display 110 without the additional processing performed by the video controller 106.

In one embodiment, the diagnostic device 108 is coupled to a vector graphics array (VGA) compatible display or monitor. Accordingly, video controller 106 is a VGA controller that generates and communicates a VGA video signal to display 110.

Video controller 106 may be configured to generate and communicate any suitable video signal format based upon the display 110 to which the video signal is sent. The video signal is a suitable electronic signal comprising video information that is displayed on the display 110. Video information may include graphical or textual information of interest to the viewer.

Coupler 124 was illustrated for convenience at the end of connection 122. Connection 122 may be a flexible electrical cord or wire-based connection of a suitable length such that the technician may conveniently attach the coupler 124 to the access port 126. Thus, the diagnostic device is configured to communicate with the modular-processing device 104 using wire-based signals. In another embodiment, connection 122 is omitted and the coupler 124 is rigidly attached to the diagnostic device 108. Thus, the technician couples the diagnostic device 108 directly to the modular-processing device 104. In another embodiment, diagnostic device 108 and modular-processing device 104 employ other suitable wireless communication media. For example, diagnostic device 108 and modular-processing device 104 may each include suitable infrared transceivers such that information is communicated between the diagnostic device 108 and the modular-processing device 104 using infrared signals. Another embodiment employs a radio frequency (RF) medium using RF transceivers.

For convenience, the display 110 is illustrated as a separate device. In another embodiment, diagnostic device 108 includes a built-in display. In other embodiments, diagnostic device 108 communicates with display 110 using a suitable wireless communication medium, described above.

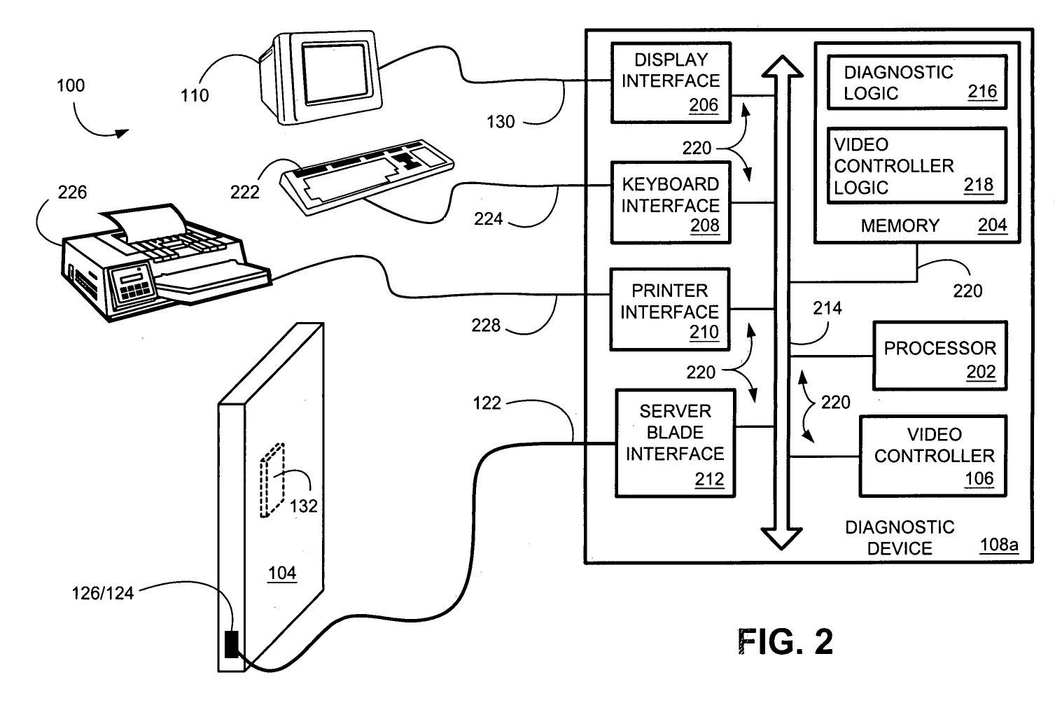

FIG. 2 is a block diagram illustrating an embodiment of the diagnostic device 108a, corresponding to the diagnostic device 108 of FIG. 1. Diagnostic device 108a includes a processor 202, a memory 204, a display interface 206, an optional keyboard interface 208, an optional printer interface 210, a server blade interface 212, a video controller 106 and a communication bus 214. Memory 204 further includes diagnostic logic 216 and video controller logic 218. Display interface 206, optional keyboard interface 208, optional printer interface 210 and server blade interface 212 may be active devices that process received communications into a format suitable for the diagnostic device 108a, and/or may be inactive connectors, such as pin connectors or the like, that provide physical coupling of their respective connections to the diagnostic device 108a.

The above-described components are communicatively coupled to each other via connections 220. In alternative embodiments of diagnostic device 108a, the above-described components are connectivley coupled to each other in a different manner than illustrated in FIG. 2. For example, one or more of the above-described components may be directly coupled to processor 202 or may be coupled to processor 202 via intermediary components (not shown).

Diagnostic logic 216 is configured to perform the various diagnostic tests applicable for testing the modular-processing device 104. Video controller logic 218 is configured to receive video information from the modular-processing device 104 such that the video controller 106 generates and communicates a suitable video signal to display 110. Diagnostic logic 216 and/or video controller logic 218 are retrieved from memory 204 and executed by processor 202. In another embodiment, video controller 106 comprises its own processor, and memory wherein the video controller logic 218 resides, such that the received video information is processed directly by the video controller 106. In yet another embodiment of diagnostic unit 108a, all or part of video controller 106 is implemented as firmware such that the received video information is processed by the video controller 106.

For convenience, the illustrated embodiment of diagnostic device 108a is configured to couple to a suitable keyboard 222. Keyboard 222 is used to provide instructions from a technician for operating the diagnostic device 108a. Keyboard 222 is coupled to the keyboard interface 208, via connection 224, such that information received from the keyboard 222 is formatted into a suitable signal that is communicated to processor 202. In an alternative embodiment, diagnostic device 108a comprises a built-in suitable keypad device (not shown) for receiving operation instructions from the technician. In yet another embodiment of diagnostic device 108a, a built-in display and one or more controllers (not shown) provide a menu system for receiving operation instructions from the technician.

For convenience, the illustrated embodiment of diagnostic device 108a is configured to couple to print device 226. Print device 226 prints received information from the diagnostic device 108a. Print device 226 is coupled to the printer interface 210, via connection 228, such that information communicated to the print device 226 is formatted into a suitable signal. In an alternative embodiment, diagnostic device 108a comprises a built-in print device.

In other embodiments of diagnostic device 108a, diagnostic data is stored into memory 204, or stored into another suitable memory device (not shown). The diagnostic data may then be retrieved and analyzed after testing the modular-processing device 104.

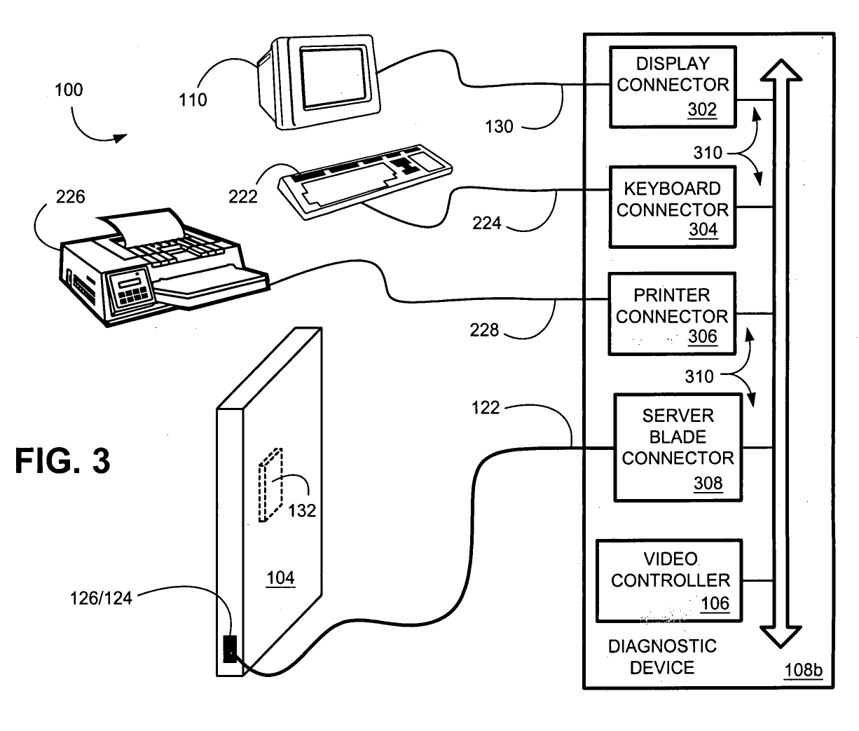

FIG. 3 is a block diagram illustrating another embodiment of the diagnostic device 108b, corresponding to the diagnostic device 108 of FIG. 1. Diagnostic device 108b includes a display connector 302, an optional keyboard connector 304, an optional printer connector 306, a server blade connector 308, a video controller 106 and an optional communication bus 310. Connectors 302, 304, 306 and 308 are inactive connectors, such as pin connectors or the like, that provide physical coupling of their above-described respective connections to the diagnostic device 108b.

The above-described components are communicatively coupled to each other via connections 310. In alternative embodiments of diagnostic device 108b, the above-described connectors 302, 304, 306 and/or 308, and/or video controller 106, may be connectivley coupled to each other in a different manner than illustrated in FIG. 2. For example, the video controller 106 may be serially connected between the server blade connector 308 and the display connector 302, or may be coupled to the connectors 308 and/or 302 via intermediary components (not shown).

Diagnostic device 108b is configured to communicate information received from a modular-processing device 104 to the other devices to which it is coupled. Accordingly, diagnostic device 108b is a passive device that does not actively process information received from the modular-processing device 104.

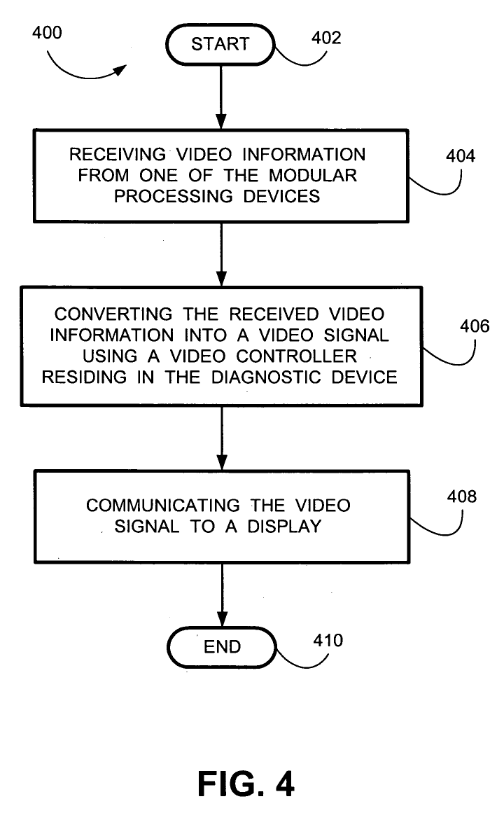

FIG. 4 shows a flow chart 400 illustrating an example process used by an embodiment of a diagnostic system 100 (FIG. 1). The flow chart 400 of FIG. 4 shows the architecture, functionality, and operation of an embodiment for implementing the video controller logic 218 (FIG. 2) such that video information received from a modular-processing device 104 is converted into a suitable video signal by a video controller 106 residing in a diagnostic device 108, 108a or 108b (FIGS. 1-3). An alternative embodiment implements the logic of flow chart 400 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIG. 4, or may include additional functions. For example, two blocks shown in succession in FIG. 4 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present disclosure.

The process begins at block 402. At block 404, video information from one of the modular-processing devices 104 is received. At block 406, the received video information is converted into a video signal using a video controller 106 residing in the diagnostic device 108a (FIG. 2) or 108b (FIG. 3). At block 408, the video signal is communicated to a display 110 (FIGS. 1 and 2). The process ends at block 410.

Embodiments of the invention implemented in memory 204 (FIG. 2) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

It should be emphasized that the above-described embodiments are merely examples of the disclosed system and method. Many variations and modifications may be made to the above-described embodiments. All such modifications and variations are intended to be included herein within the scope of this disclosure and protected by the following claims.

1. A diagnostic device that tests at least one modular-processing device, the diagnostic device comprising:
a coupler configured to communicatively mate with an access port residing on the modular-processing device; and
a video controller configured to receive video information from the modular-processing device and configured to generate a video signal that is communicated to a display.

2. The diagnostic device of claim 1, wherein the video controller further comprises a vector graphics array (VGA) controller configured to communicate a VGA video signal to a VGA display.

3. The diagnostic device of claim 1, further comprising the display.

4. The diagnostic device of claim 1, wherein the coupler comprises a coupler configured to communicate signals using a wire-based medium.

5. The diagnostic device of claim 1, wherein the coupler is configured to communicate signals using a wireless medium.

6. The diagnostic device of claim 1, wherein the modular-processing device is a server blade.

7. A testing system comprising:
a plurality of modular-processing devices, each of the modular-processing devices being configured to communicate at least video information;
a diagnostic device configured to communicatively couple to one of the modular-processing devices; and
a video controller residing in the diagnostic device and configured to receive the video information from the modular-processing device, and further configured to generate a video signal that is communicated to a display.

8. The system of claim 7, wherein the video controller comprises a vector graphics array (VGA) controller configured to communicate a VGA video signal to a VGA display.

9. The system of claim 7, wherein the plurality of modular-processing devices comprises a plurality of server blades.

10. A method for testing modular-processing devices with a diagnostic device, the method comprising:
receiving video information from one of the modular-processing devices;
converting the received video information into a video signal using a video controller residing in the diagnostic device; and
communicating the video signal to a display.

11. The method of claim 10, wherein converting the received video information into the video signal comprises converting the received video information into a vector graphics array (VGA) video signal using a VGA controller.

12. The method of claim 11, wherein communicating the video signal to the display comprises communicating the VGA video signal to a VGA display.

13. The method of claim 10, wherein receiving the video information comprises receiving the video information from a server blade.

14. A system for testing modular-processing device, the system comprising:
means for communicatively coupling a diagnostic device to a modular-processing device;
means for receiving video information from the modular-processing device;
means for converting the received video information into a video signal using a video controller residing in the diagnostic device; and
means for communicating the video signal to a display.

15. The system of claim 14, wherein the means for converting comprise means for converting the received video information into a vector graphics array (VGA) video signal using a VGA controller.

16. The system of claim 15, wherein the means for communicating comprise means for communicating the VGA video signal to a VGA display.

17. The system of claim 14, wherein the means for receiving the video information comprise means for receiving the video information from a server blade.

18. A modular-processing device, comprising:
an access port configured to communicatively mate with a coupler residing on a diagnostic device; and
a processor configured to generate video information in response to testing initiated by the diagnostic device,
wherein the communicated video information is processed by a video controller that is configured to receive the video information and generate a video signal that is communicated to a display.

19. The modular-processing device of claim 18, wherein the modular-processing device is a server blade.

20. The modular-processing device of claim 18, wherein the video controller comprises a vector graphics array (VGA) controller that is configured to communicate a VGA video signal to a VGA display.
